(19) United States
(12) Patent Application Publication
(10) Pub. No.: US 2017/0075932 A1
(43) Pub. Date: Mar. 16, 2017

(54) LOG STORAGE OPTIMIZATION

(71) Applicant: EMC Corporation, Hopkinton, MA (US)

(72) Inventors: Grissom Tianqing Wang, Shanghai (CN); Patrick Minggang Lu, Shanghai (CN); Chao Chen, Shanghai (CN); Hao Xu, Shanghai (CN); Jie Bao, Shanghai (CN); Jinlong Ma, Shanghai (CN)

(21) Appl. No.: 15/263,805

(22) Filed: Sep. 13, 2016

(30) Foreign Application Priority Data
Sep. 16, 2015 (CN) CN201510589748.4

(51) Int. Cl. G06F 17/30

(52) U.S. Cl. CPC G06F 17/30312; G06F 17/30377

(57) ABSTRACT

Embodiments of the present disclosure relate to a method and apparatus for log storage optimization by receiving log data, s converting the log data into structured data using a parsing rule, and encoding the structured data to reduce a storage space of the log.

### RELATED APPLICATION

This application claim priority from Chinese Patent Application Number CN201510589748.4, filed on Sep. 16, 2015 at the State Intellectual Property Office, China, titled “METHOD AND APPARATUS FOR LOG STORAGE OPTIMIZATION,” the contents of which is herein incorporated by reference in entirety.

### FIELD OF THE DISCLOSURE

Embodiments of the present disclosure generally relate to data storage technologies.

### BACKGROUND OF THE DISCLOSURE

Computer systems are constantly improving in terms of speed, reliability, and processing capability. As is known in the art, computer systems which process and store large amounts of data typically include a one or more processors in communication with a shared data storage system in which the data is stored. The data storage system may include one or more storage devices, usually of a fairly robust nature and useful for storage spanning various temporal requirements, e.g., disk drives. The one or more processors perform their respective operations using the storage system. Mass storage systems (MSS) typically include an array of a plurality of disks with on-board intelligent and communications electronics and software for making the data on the disks available.

Companies that sell data storage systems are very concerned with providing customers with an efficient data storage solution that minimizes cost while meeting customer data storage needs. It would be beneficial for such companies to have a way for reducing the complexity of implementing data storage.

### SUMMARY OF THE DISCLOSURE

In view of the above, embodiments of the present disclosure provide a method and apparatus for log storage optimization, which can reduce storage space of the log and improve log analysis efficiency. According to an embodiment of the present disclosure, an apparatus and a method for log storage optimization includes receiving log data; converting the log data into structured data using a parsing rule; and encoding the structured data to reduce storage space of the log.

### BRIEF DESCRIPTION OF DRAWINGS

Features, advantages and other aspects of embodiments of the present disclosure will be made more apparent in combination with figures and with reference to the following detailed description. Several embodiments of the present disclosure are illustrated here in an exemplary and unrestrictive manner. In the figures,

FIG. 1 illustrates a flow chart of a method 100 for log storage optimization according to an exemplary embodiment of the present disclosure;

FIG. 2 illustrates an example of a log record according to an exemplary embodiment of the present disclosure;

FIG. 3 illustrates an example of parsing a log record according to an exemplary embodiment of the present disclosure;

FIG. 4 illustrates an example of describing a structured log profile according to an exemplary embodiment of the present disclosure;

FIG. 5 illustrates an example of parsing the log content part using a regular expression according to an exemplary embodiment of the present disclosure;

FIG. 6 illustrates an example of parsing the log content part using a string template according to an exemplary embodiment of the present disclosure;

FIG. 7 illustrates an example of reducing timestamp entropy through relative encoding according to an exemplary embodiment of the present disclosure;

FIG. 8 illustrates an example of analyzing generic log segment from a perspective of column according to an exemplary embodiment of the present disclosure;

FIG. 9 illustrates an example of a finite set of module names according to an exemplary embodiment of the present disclosure;

FIG. 10 illustrates an example of encoding log data according to an exemplary embodiment of the present disclosure;

FIG. 11 illustrates a flow chart of generating an adaptive learning process of coding rules according to another exemplary embodiment of the present disclosure;

FIG. 12 illustrates a processing workflow of a method for the log storage optimization according to another exemplary embodiment of the present disclosure;

FIG. 13 illustrates an example of a result of storage optimization of log data according to an exemplary embodiment of the present disclosure;

FIG. 14 illustrates a block diagram of an apparatus 1400 for log storage optimization according to an exemplary embodiment of the present disclosure; and

FIG. 15 illustrates a block diagram of a computer device 1500 in which an exemplary embodiment of the present disclosure may be implemented.

### DETAILED DESCRIPTION

Exemplary embodiments of the present disclosure will be described in detail with reference to figures. The flowcharts and block diagrams in the figures illustrate system architecture, functions and operations executable by a method and system according to the embodiments of the present disclosure. It should be appreciated that each block in the flowcharts or block diagrams may represent a module, a program segment, or a part of code, which contains one or more executable instructions for performing specified logic functions. It should also be noted that, in some alternative implementations, the functions noted in the block may occur out of the order noted in the figures. For example, two blocks shown consecutively may be performed in parallel substantially or in an inverse order, depending on involved functions. It should also be noted that each block in the block diagrams and/or flow charts and a combination of blocks in block diagrams and/or flow charts may be implemented by a dedicated hardware-based system for executing a prescribed function or operation or may be implemented by a combination of dedicated hardware and computer instructions.

The terms “comprising”, “including” and their variants used herein should be understood as open terms, i.e., “comprising/including, but not limited to”. The term “based on” means “at least partly based on”. The term “an embodiment” represents “at least one embodiment”; the terms “another embodiment” and “a further embodiment” represent “at least one additional embodiment”. Relevant definitions of other terms will be given in the description below.

Generally, logs may be records of a transaction or an operation occurring at a system (such as software, application) or an apparatus (such as a server or terminal equipment). Log data may contain a definitive record of all activities and behaviors of a system or an apparatus, and may be generally semi-structured data, such as a single-line log and a complex multi-line log. Technicians usually search, correlate, visualize, analyze and record log data may be used to identify and resolve operation and security issues of the system or apparatus.

Modern Software-Defined Data Center (SDDC) infrastructure may be constantly generating log data at a rate faster than a rate that technical technicians can handle. Since the amount and activities and data increases exponentially, a number of generated logs may also increases rapidly. For example, some storage servers may generate log data of up to several TBs each day. The modern SDDC infrastructure may have an automated and dynamic deployment capability for multi-tier applications, and thus it may necessitate real-time log analytics. Effective analysis of a log may be a key guarantee for complex troubleshooting, dynamic high performance and superior security.

Generally, methods of performing search and analysis for a log may be very inefficient. Additionally, although existing processing approaches use compression or deduplication processing, entropy of a log may not been reduced, and hence processing current massive logs and improving log analysis efficiency remains an potential issue.

It should be appreciated that these exemplary embodiments are presented here to enable those skilled in the art to better understand and thereby implement embodiments of the present disclosure, not to limit the scope of the present disclosure in any manner.

According to one embodiment, there is disclosed a method for log storage optimization. A further embodiment may include receiving log data. A further embodiment may include converting log data into structured data using a parsing rule. A further embodiment may include encoding structured data to reduce storage space of the log. A further embodiment may include traversing a log profile repository after receiving log data. A further embodiment may include determining whether a log profile repository includes a structured log profile corresponding to a log data to generate a parsing rule, wherein a structured log profile repository may be used to store converted structured data.

In a further embodiment, determining whether a log profile repository includes a structured log profile corresponding to a log data to generate the parsing rule may include if a log profile repository includes a structured log profile corresponding to a log data, generating a corresponding parsing rule according to a corresponding structured log profile.

In a further embodiment, determining whether a log profile repository includes a structured log profile corresponding to a log data to generate the parsing rule may include: if a structured log profile corresponding to a log data is missed in a log profile repository, obtaining a structured log profile and parsing rule corresponding to a log data through an adaptive learning process. A further embodiment may include receiving a structured log profile and parsing rule corresponding to a log data from a user.

A further embodiment may include prior to traversing a log profile repository, generating a structured log profile and a corresponding parsing rule according to a log configuration accessible to a device receiving a log data. In a further embodiment, a structured log profile may at least include a timestamp or content data of the log. In a further embodiment, a parsing rule may be a regular expression or string template.

In a further embodiment, converting a log data into structured data using a parsing rule further may include setting a base time after converting a log data into a structured data using a parsing rule. A further embodiment may include determining a time difference between a timestamp of each log and a base time. A further embodiment may include replacing a timestamp data in a structured data with a time difference. In a further embodiment, a base time may be a timestamp of a first log or periodicity-based time.

In a further embodiment, encoding structured data may include: for various types of value in the structured data, determining an occurrence frequency of each value in the same type of values to generate an encoding rule. In a further embodiment, generating encoding rules may include: encoding a value having a larger occurrence frequency as a number having a shorter length, wherein an occurrence frequency may be proportional to occurrence times. In a further embodiment, encoding a value having a larger occurrence frequency as a number having a shorter length may include: encoding a value having a maximum occurrence frequency as a number “1”.

In a further embodiment generating encoding rules may include: generating automatically an encoding rule according to an adaptive learning process of the encoding rule. In a further embodiment, an encoding rule may be implemented by Huffman encoding. A further embodiment may include storing an encoded structured data in a form of a log vector after encoding a structured data using an encoding rule.

In one embodiment an apparatus for log storage optimization may include a receiving unit that may be configured to receive log data; a converting unit that may be configured to convert log data into structured data using a parsing rule; and an encoding unit that may be configured to encode structured data to reduce storage space of a log.

Exemplary embodiments of the present disclosure may bring about at least one of the following technical effects: since structured conversion may be performed for a log data, converted data may be encoded in a column-based manner, and/or a timestamp of a log may be encoded, and thus an analysis efficiency of a log may be significantly improved and an entropy of a log may be effectively reduced, thereby achieving an effect of reducing storage space of logs and thereby improving archiving efficiency of logs.

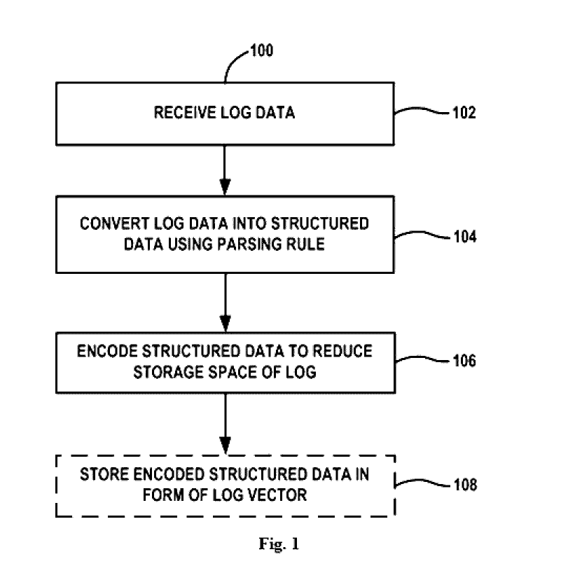

FIG. 1 illustrates a flow chart of a method 100 for log storage optimization according to an exemplary embodiment of the present disclosure. Referring to FIG. 1, at step 102, log data is received. At step 104, the log data is converted into the structured data using the parsing rule. At step 106, the structured data is encoded to reduce the storage space of the log. Optionally, the method further comprises a step 108 of storing the encoded structured data in the form of a log vector after encoding the structured data using the encoding rule. In an example embodiment, log generated by a system or apparatus may be input into a processing device for performing storage optimization for log data. In a further embodiment, an input manner may be direct connection via an interface or an input via in an import manner. In a further embodiment, a log data may be received in real time or regularly, for example, log data may be received once every 24 hours. In a further embodiment, received log data may include various types of logs, such as common logs, error logs and the like.

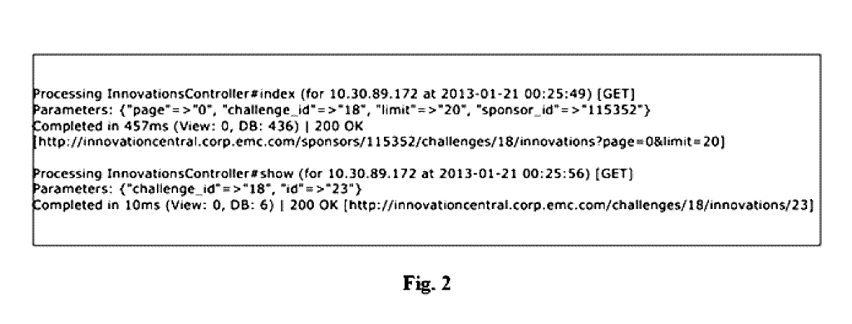

Referring to FIG. 2, it illustrates an example of a log record according to an exemplary embodiment of the present disclosure. In one embodiment, log data may include multiple logs in a same type, or may comprise multiple logs in different types. In FIG. 2, two logs in the same type are shown, and the logs are presented in a semi-structured form. In an example in FIG. 2, each log may include information such as a module name, IP address, timestamp, operation type, parameters, and log content.

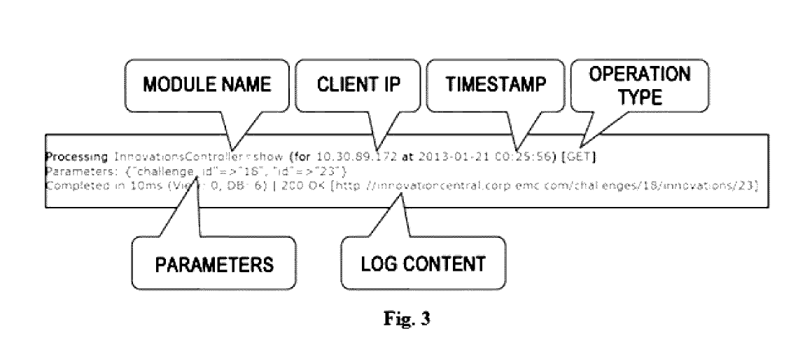

FIG. 3 illustrates an example of parsing a log record according to an exemplary embodiment of the present disclosure. In FIG. 3, first semi-structured log in FIG. 2 is analyzed, and a first log record may be parsed into six fields: a module name, client IP address, timestamp, operation type, parameters, and log content. In the log shown in FIG. 3, a value of the module name is “InnovationController”, a value of a client IP address is “10.30.89.172”, a value of a timestamp is “2013-01-21 00:25:56”, a value of an operation type is “GET”, a value of parameters is ““challenge_id”=>“18”, “id”=>“23””, and a value of log content is “Completed in 10 ms (View: 0, DB: 6) |200 OK [http://innovationcentral.corp.emc.com/challenges/18/innovations/23]”.

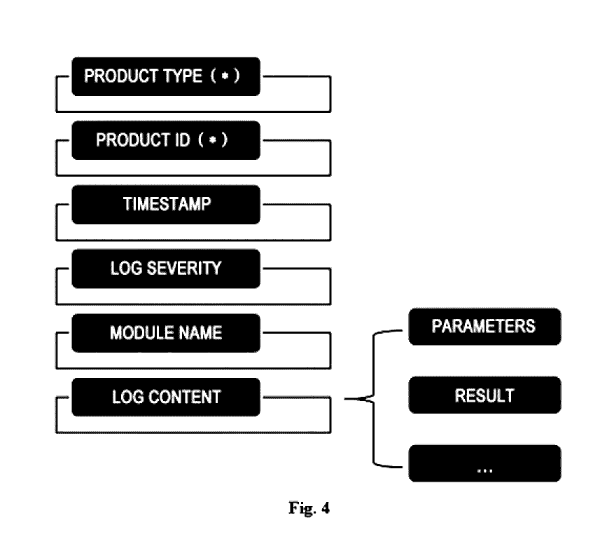

FIG. 4 illustrates an example of describing a structured log profile according to an exemplary embodiment of the present disclosure. A log profile is used to describe a general format or layout of a log record. A structured log profile may be used to store structured log data extracted from the log record. The profile in FIG. 4 for example includes product type, product ID, timestamp, log severity, module name, and log content. The log content may specifically comprise fields such as parameters and result. Regarding different types of logs, a structured log profile may include field content of different log profiles, but each log record certainly includes both a timestamp and log content. In a structured log profile repository, corresponding log profile types may be built for different types of log records. For example, a log profile may be represented as Log profile=[profile name, Regular expression Template|String Template, item name 1, item name 2, . . . ]. In addition, regarding commonly-used log formats (such as Apache log) in the art, log profiles of these log formats may be defined in advance.

After step 102 illustrated in FIG. 1, in one embodiment method 100 may further include: traversing a log profile repository after receiving log data, and determining whether a log profile repository includes a structured log profile corresponding to the log data to generate a parsing rule, wherein the structured log profile repository may be used to store converted structured data. According to another embodiment, a parsing rule may be a regular expression or a string template.

In a further embodiment, a regular expression may be a matching tool for operating and checking string data, it may be a sting of special characters and may perform operations such as matching for a text. In a further embodiment, reference for matching grammar of a regular expression may be made to a web site http://www.regular-expressions.info/. In an example embodiment, a regular expression for matching may be built for a log record in FIG. 2 as follows:

P1=[“Processing\s+(\w+)#(\w+)\s\(for\s+((\d+\.){3}\d+)\s+at\s+(\d+−\d+−\d+\s\d+:\d+:\d+)\)\s+\[(\w+)\]\n+(Parameters:\.+)”, controller, method, client_IP, timestamp, http_method, content].

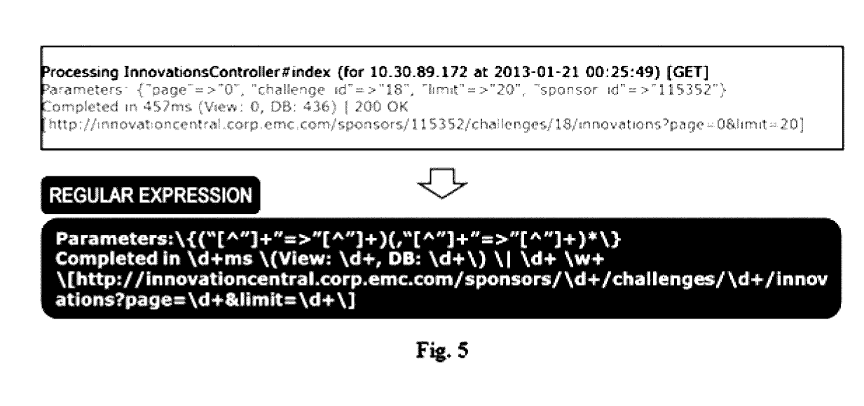

In a further embodiment, data matched by a regular expression may be considered as data at respective field positions in a log profile. In a further embodiment, in the above example of a regular expression, a value of a controller field may correspond to “\w+”, a value of method field may correspond to “\w+”, a value of client_IP field may correspond to “(\d+\.){3}\d+”, a value of timestamp field may correspond to “\d+−\d+−\d+\s\d+:\d+:\d+”, a value of http_method field may correspond to “\w+”, and a value of content field may correspond to “Parameters:\.+”. In a further embodiment, by using matching rules of a regular expression, matching may be performed for a log record in the example of FIG. 2 so as to parse and extract structured log data in a log record. FIG. 5 illustrates an example of parsing a log content part using a regular expression, and dynamic data in a log content can be parsed and extracted. In one embodiment, a string template may be a template matching engine, which may support programming language such as java, C#, Python or the like. In a further embodiment, reference for a matching grammar of a string template may be made to a web site http://www.stringtemplate.org/. In a further embodiment, a specific matching grammar of a string template may be somewhat different from that of a regular expression. In a further embodiment, both a regular expression and a string template may achieve an effect of extracting a log record.

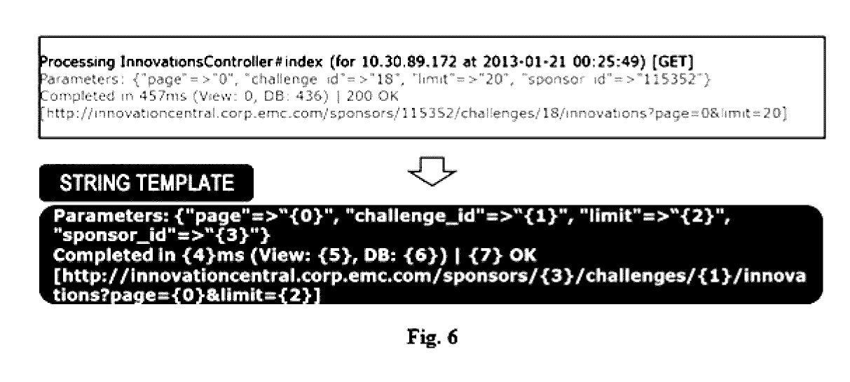

FIG. 6 illustrates an example of parsing a log content part using a string template. By using a matching rule of a string template shown in FIG. 6, a semi-structured log record will be converted into a structured form. Then, the converted structured data may be stored in the structured log profile repository in a vector form. For example, the vector may be represented as: [P1, ‘InnovationController’, ‘index’, ‘10.30.89.172’, ‘2013-01-21 00:25:49’, GET, [ST1, 0, 18, 20, 115352, 457, 0, 436, 200]].

In one embodiment, both a regular expression and a string template matching rules may be received from a user, or may be automatically obtained by executing adaptive learning process according to historical log records and log profiles. In an example embodiment, an original log record and a structured log profile may be compared in terms of text in order to obtain positions of changing data in an original log record, that is, to obtain variables in a log record. In a further embodiment, a learning process may be repeated to generate a respective parsing rule, such as a regular expression and a string template.

According to an embodiment, determining whether a log profile repository includes a structured log profile corresponding to a log data to generate a parsing rule may include: if a log profile repository includes a structured log profile corresponding to a log data, generating a corresponding parsing rule according to a corresponding structured log profile. In an example embodiment, if a log profile repository already includes a corresponding log profile, a corresponding parsing rule may be generated according to this log profile.

According to another embodiment, determining whether a log profile repository includes a structured log profile corresponding to a log data to generate a parsing rule may include: if a structured log profile corresponding to a log data is missed in a log profile repository, obtaining a structured log profile and parsing rule corresponding to a log data through an adaptive learning process, or receiving a structured log profile and parsing rule corresponding to a log data from a user. In an example embodiment, if a log profile repository does not include a corresponding log profile, a parsing rule may be received from a user. In an alternative embodiment, a corresponding parsing rule may be generated automatically through an adaptive learning process of a parsing rule.

According to an embodiment, method 100 further includes: prior to traversing a log profile repository, generating a structured log profile and a corresponding parsing rule according to a log configuration accessible to a device receiving a log data. In one embodiment, during software development, Log4j tool may be usually used to assist in generating a log. In a further embodiment, if a configuration file for Log4j can be obtained, a log generating rule may be obtained. In a further embodiment, Log4j(http://logging.apache.org/log4j) is a powerful log recording software and uses a grammar description layout. In an example embodiment, “%-5p [% t]: % m % n” may generate log severity in 5 characters+[thread name]: message+line breaks. In a further embodiment, during a process of log conversion, if a log configuration (such as Log4j configuration) of generating a log data can be obtained, Log4j configuration may be used to generate a log profile and a corresponding parsing rule. In a further embodiment, if Log4j configuration cannot be obtained, a log profile repository continues to be traversed to obtain a structured log profile and a parsing rule.

Further referring to FIG. 1 again, at step 104, in one embodiment, log data is converted into structured data using a parsing rule. In a further embodiment, a log record may be converted through a parsing rule generated above so that the log record may be converted into a structured data, and the converted structured data may be stored in a vector form as above-mentioned. In a further embodiment, a parsing rule may be generated automatically or manually. According to an embodiment, in method 100, a base time may be set after converting a log data into a structured data using a parsing rule. In a further embodiment, a time difference between a timestamp of each log and a base time may be determined, and this time difference may be used to replace a timestamp data in a structured data. According to another embodiment, a base time is a timestamp of a first log or periodicity-based time.

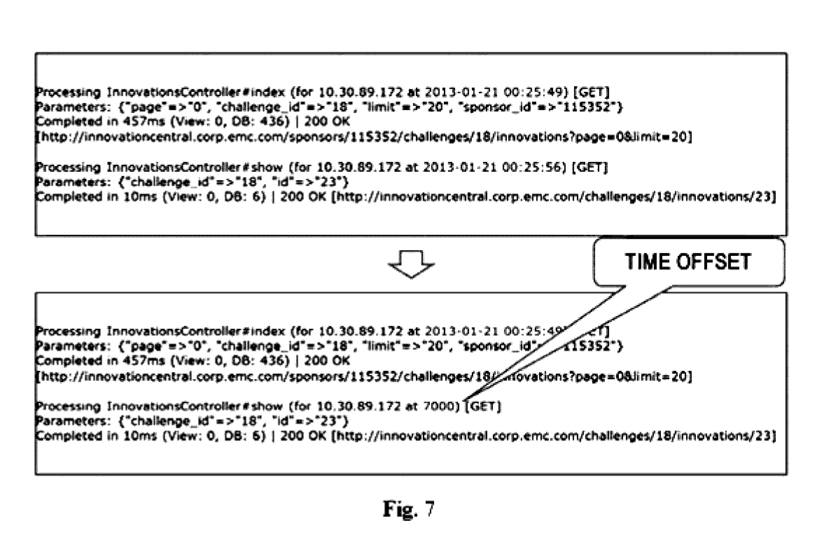

FIG. 7 illustrates an example of reducing timestamp entropy through relative encoding according to an exemplary embodiment of the present disclosure. In one embodiment, logs may be generally generated continuously, and a time difference between two logs may be often closer. In a further embodiment, if a timestamp of each log is stored individually (such as “2013-01-21 00:25:49”, “2013-01-21 00:25:56”, a larger storage space may be occupied. In a further embodiment, hence, an entropy of a timestamp may be reduced through relative encoding (such as timestamp vertical encoding). In the example embodiment in FIG. 7, a time of a first log may be selected as a base time, a time of a second log “2013-01-21 00:25:56” may be encoded as relative time “7000”, and a field of a timestamp in a log profile may have reduced 15 characters, thereby effectively reducing a storage space of a log. In an additional embodiment, a base time may be periodicity-based time, for example, a first second of each hour may be set as a base time.

Further referring to FIG. 1, in one embodiment, at step 106, a structured data may be encoded to reduce a storage space of a log. In a further embodiment, in modern SDDC, massive logs may be generated constantly. In a further embodiment, hence, after formalized conversion is performed for a log record, a storage space occupied by a log may still be relatively large. In a further embodiment, hence, it may be desirable to provide an effective encoding method to encode a converted log data to reduce a storage space of the logs.

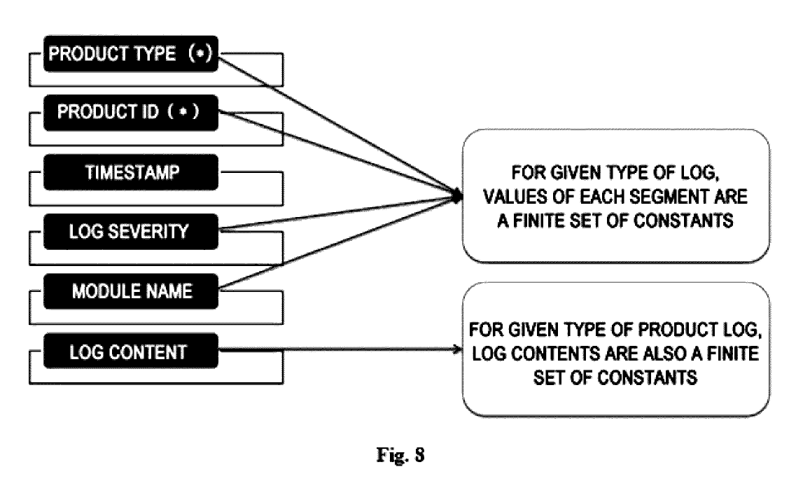

FIG. 8 illustrates an example of analyzing generic log segment from a perspective of column according to an exemplary embodiment of the present disclosure. In one embodiment, for a given type of product log, values of each segment may be a finite set of constants. In a further embodiment, for a given type of product log, log contents may be a finite set of constants. In the example embodiment in FIG. 8, values of other fields, except for a timestamp, all may be a finite set. In a further embodiment, regarding a timestamp, the timestamp may be encoded through a relative encoding as in FIG. 7; and regarding other fields, these fields may be encoded using a column-based encoding rule.

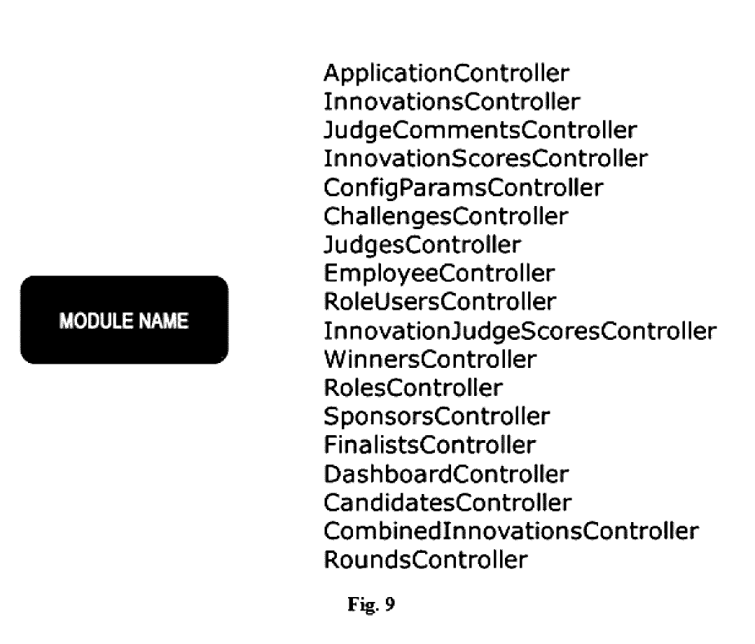

FIG. 9 illustrates an example of a finite set of module names according to an exemplary embodiment of the present disclosure. In an example embodiment, a finite set of module names may include 18 values. According to an embodiment, encoding a structured data may include: for various types of values in a structured data, determining an occurrence frequency of each value in same type of values to generate an encoding rule. According to another embodiment, generating an encoding rule may include: encoding a value having a larger occurrence frequency as a number having a shorter length, wherein an occurrence frequency may be proportional to occurrence times. In an example embodiment, as illustrated in FIG. 9, an occurrence frequency of each of module names in a finite set may be determined. In an example embodiment, among 10,000 log records, module name InnovationsController occurs totally 3,000 times, and thus occurrence frequency of the module name InnovationsController is 30%; module name ApplicationController occurs totally 2,200 times, and thus occurrence frequency of the module name ApplicationController is 22%.

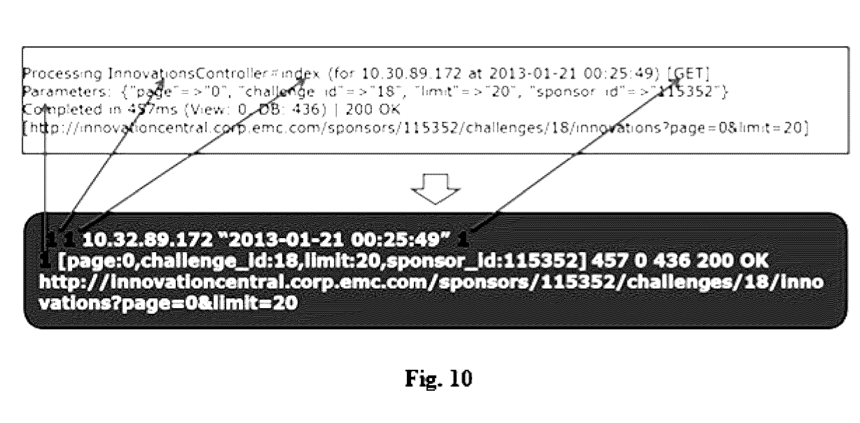

FIG. 10 illustrates an example of encoding log data according to an exemplary embodiment of the present disclosure. In an example embodiment of FIG. 10, encoding a value having a larger occurrence frequency as a number having a shorter length may include: encoding a value having a maximum occurrence frequency as a number “1”. In a further embodiment, since an occurrence frequency of module name InnovationsController is maximum among all modules, a value InnovationsController may be encoded as a number “1”, and a value ApplicationController with a second highest occurrence frequency may be encoded as value “2”. In a further embodiment, considering encoded log vectors, all numbers of “1” in the column of module name represent module name “InnovationsController”, and all values “2” represent module name “ApplicationController”. In an example embodiment of FIG. 10, “index”, “GET” and “Parameters” in other columns with a highest occurrence frequency may also be encoded as a number “1” respectively.

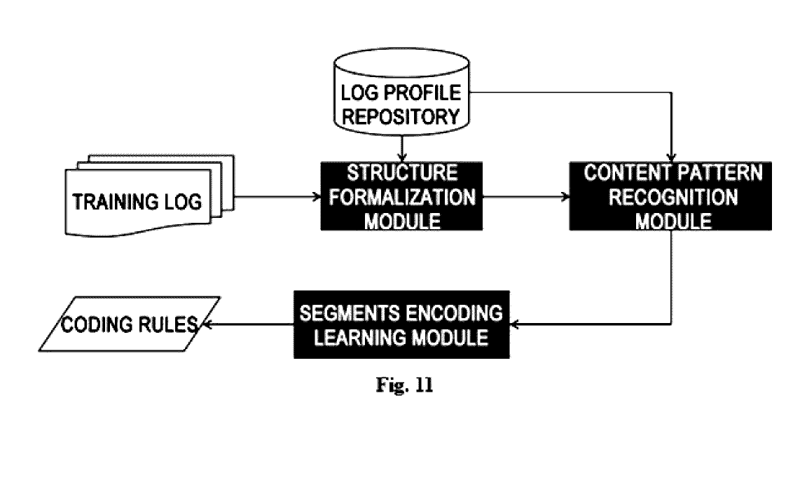

FIG. 11 illustrates a flow chart of generating an adaptive learning process of coding rules according to another exemplary embodiment of the present disclosure. In an optional embodiment, generating encoding rules may include: generating automatically an encoding rule according to an adaptive learning process of the encoding rule. In a further embodiment, as shown in FIG. 11, a structured log data may be obtained through a training log and a log profile repository, and a segment encoding learning module records all possible values of each log segment (column) in a log profile and generates an encoding rule according to these values.

According to an embodiment, an encoding rule may be Huffman encoding. In one embodiment, Huffman encoding, according to occurrence frequency of characters, constructs a code word of a different prefix with a shortest average length, and may be a typical lossless compression encoding. In a further embodiment, Huffman encoding may be used to encode converted structured data in order to further reduce information entropy of a log.

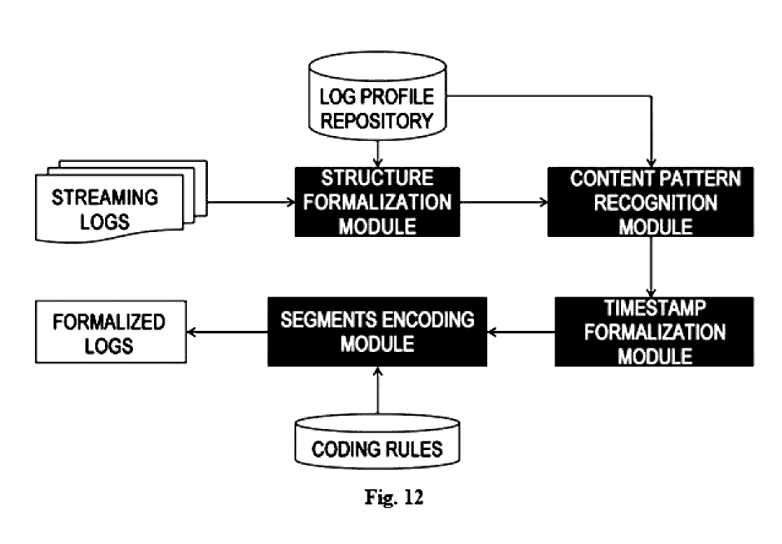

FIG. 12 illustrates a processing workflow of a method for log storage optimization according to another exemplary embodiment of the present disclosure. In one embodiment, a log profile repository stores known log profile vectors, including log profiles stored historically and profiles in log format that may be customarily used. In a further embodiment, in order to accelerate a conversion process, a mapping from source streaming logs to log profile vectors may be cached. In a further embodiment, logs may be input continuously into a processing system, and a structure formalization module may use a log profile if a log profile is found in a cache or log profile repository. In a further embodiment, a content pattern recognition module may parse a value of a dynamic variable in a log record based on a log profile and a parsing rule. In a further embodiment, parsing processing may be performed for a log content part by using the same technology.

In a further embodiment, for a timestamp of a log, a Timestamp Formalization Module may determine a time offset based on a base time, and a offset may be, for example, a time difference between a current log record and a previous log record. In a further embodiment, for each segment (column) of a log record, a segment encoding module uses a corresponding encoding rule to generate an encoded formulized log. In a further embodiment, an encoded log may be a series of encoded log vectors. In an example embodiment, encoding rules may be generated by a training process as disclosed in FIG. 11. In a further embodiment, it may also be possible to determine a finite set of each field (column) in real time to generate an encoding rule in real time and dynamically.

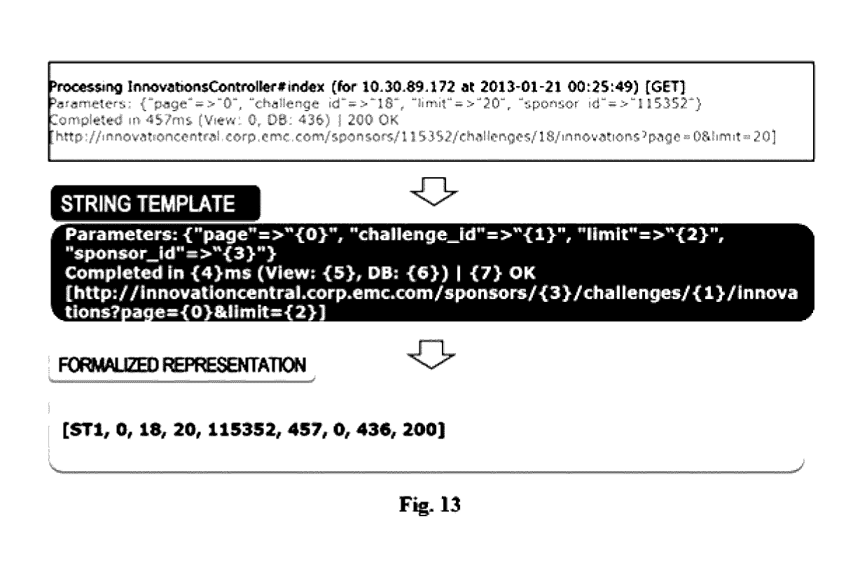

FIG. 13 illustrates an example of a result of storage optimization of log data according to an exemplary embodiment of the present disclosure. In an optional embodiment, method 100 further includes a step 108 of storing an encoded structured data in a form of a log vector after encoding a structured data using an encoding rule. In an example embodiment, a log record in FIG. 13 may be converted and encoded into a vector “[ST1, 0, 18, 20, 115352, 457, 0, 436, 200]”. In a further embodiment, according to a log profile and encoding rule, it may be very convenient to obtain an original value of each field in a log vector and its meaning. In a further embodiment, a method for log storage optimization according to principles of the present disclosure not only implements structuring of a log data, but also prominently reduces a storage space of the logs.

In one embodiment. a method for log storage optimization according to principles of the present disclosure improves a log storage efficiency (information entropy is reduced) and log analysis efficiency (log is converted into the form of a structured vector) through a context-aware matching approach and segment (column)-based encoding approach. In a further embodiment, a method may be adopted to perform compression and deduplication for logs again. A further embodiment may include generating encoded structured data, and structured data may be easily compared. In an example embodiment, an encoded structured data may be further analyzed by using analysis technologies such as an association rule. In a further embodiment, a method according to embodiments of the present disclosure may fit log analysis very well.

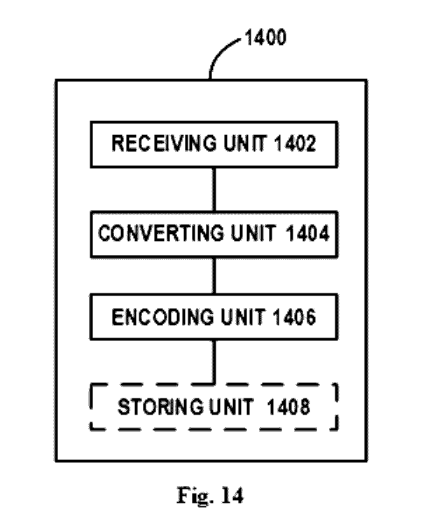

FIG. 14 illustrates an apparatus 1400 for log storage optimization according to an exemplary embodiment of the present disclosure. The apparatus comprises: receiving unit 1402 configured to receive log data; converting unit 1404 configured to convert the log data into structured data using the parsing rule; and encoding unit 1406 configured to encode the structured data to reduce storage space of the log.

According to one embodiment, apparatus 1400 may further include: a traversing unit that may be configured to traverse a log profile repository after receiving log data, and a determining unit that may be configured to determine whether a log profile repository includes a structured log profile corresponding to a log data to generate a parsing rule, wherein the structured log profile repository may be used to store a converted structured data.

According to another embodiment, the determining unit may be further configured to: if a log profile repository includes a structured log profile corresponding to a log data, generate a corresponding parsing rule according to a corresponding structured log profile. According to another embodiment, the determining unit may be further configured to: if a structured log profile corresponding to a log data is missed in a log profile repository, obtain a structured log profile and parsing rule corresponding to the log data through an adaptive learning process, or receive a structured log profile and parsing rule corresponding to the log data from a user.

According to one embodiment, apparatus 1400 may further include: a log configuration detecting unit that may be configured to, prior to traversing a log profile repository, generate a structured log profile and a corresponding parsing rule according to a log configuration accessible to a device receiving the log data. According to another embodiment, a structured log profile may at least include a timestamp or content data of a log. According to a further embodiment, a parsing rule may be a regular expression or a string template.

According to one embodiment, apparatus 1400 may further include: a timestamp encoding unit that may be configured to set a base time after a parsing rule is used to convert a log data into a structured data, to determine a time difference between a timestamp of each log and a base time, and to replace a timestamp data in a structured data with a time difference. According to another embodiment, a base time may be a timestamp of a first log or periodicity-based time.

According to one embodiment, encoding unit 1406 may be further configured to: for each type of value in a structured data, determine an occurrence frequency of each value in a same type of value to generate an encoding rule. According to another embodiment, encoding unit 1406 may be further configured to encode a value having a larger occurrence frequency as a number having a shorter length, wherein an occurrence frequency may be proportional to occurrence times. According to a further embodiment, encoding unit 1406 may be further configured to encode a value having a maximum occurrence frequency as a number “1”. According to one embodiment, encoding unit 1406 may be further configured to: generate automatically an encoding rule according to an adaptive learning process of the encoding rule. According to another embodiment, an encoding rule may be Huffman encoding. According to one embodiment, optionally, apparatus 1400 may further include: a storage unit 1408 that may be configured to store an encoded structured data in the form of a log vector after encoding a structured data using an encoding rule.

It should be appreciated that apparatus 1400 may be implemented in various manners. For example, in some embodiments, apparatus 1400 may be implemented in software, hardware or the combination thereof. The hardware part can be implemented by a special logic; the software part can be stored in a memory and executed by a proper instruction execution system such as a microprocessor or a design-specific hardware. Those skilled in the art may understand that the above method and system may be implemented with a computer-executable instruction and/or in a processor controlled code, for example, such code is provided on a carrier medium such as a magnetic disk, CD, or DVD-ROM, or a programmable memory such as a read-only memory or a data carrier such as an optical or electronic signal carrier. The apparatus and their units in the embodiments of the present disclosure may be implemented by hardware circuitry of a programmable hardware device, such as a very large scale integrated circuit or gate array, a semiconductor such as logical chip or transistor, or a field-programmable gate array, or a programmable logical device, or implemented by software executed by various kinds of processors, or implemented by combination of the above hardware circuitry and software.

It should be noted that although a plurality of units or sub-units of the apparatus have been mentioned in the above detailed description, such partitioning is merely exemplary and non-compulsory. Actually, according to embodiments of the present invention, features and functions of the above described two or more units may be embodied in one unit. In turn, features and functions of the above described one unit may be further embodied in many units.

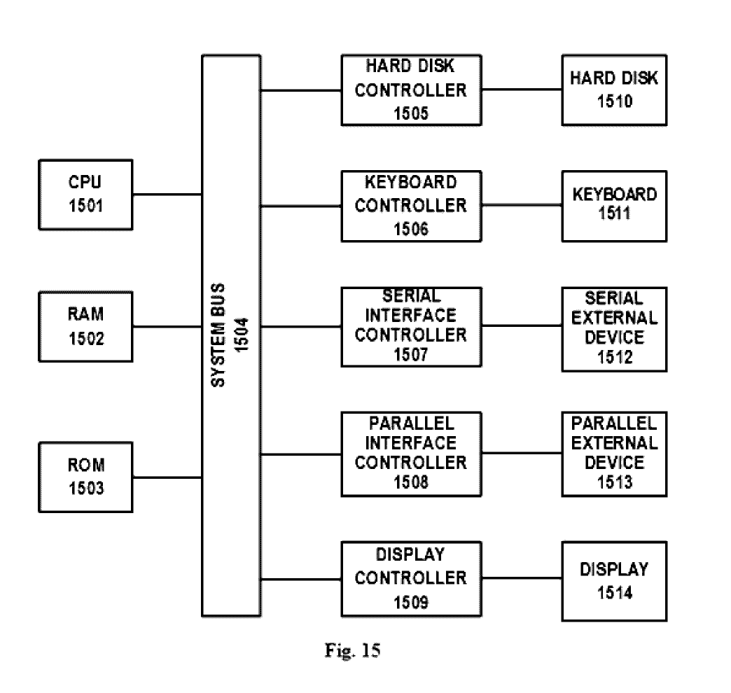

The computer device as shown in FIG. 15 includes: CPU (central processing unit) 1501, RAM (random access memory) 1502, ROM (read only memory) 1503, system bus 1504, hard disk controller 1505, keyboard controller 1506, serial interface controller 1507, parallel interface controller 1508, display controller 1509, hard disk 1510, keyboard 1511, serial external device 1512, parallel external device 1513 and display 1514. In these devices, what are coupled to system bus 1504 include CPU 1501, RAM 1502, ROM 1503, hard disk controller 1505, keyboard controller 1506, serial controller 1507, parallel controller 1508, and display controller 1509. Hard disk 1510 is coupled to hard disk controller 1505, keyboard 1511 is coupled to keyboard controller 1506, serial external device 1512 is coupled to serial interface controller 1507, parallel external device 1513 is coupled to parallel interface controller 1508, and display 1514 is coupled to display controller 1509. It should be understood that the structural block diagram as shown in FIG. 15 is only illustrated for exemplary purposes, not for limiting the scope of the present invention. In some cases, some devices may be added or reduced dependent on specific situations. Embodiments of the present disclosure may be stored in a storage device such as hardware 1510 of the above computer as a computer program code, and when it is loaded into for example a memory to run, it enables CPU 1501 to execute the method for log storage optimization according to an embodiment of the present disclosure.

What are described above are only optional embodiments of the present disclosure and not intended to limit embodiments of the present disclosure. For those skilled in the art, embodiments of the present disclosure may have various modifications and variations. Any modifications, equivalent substitutions and improvements made within the spirit and principle of embodiments of the present disclosure all should be included in the protection scope of embodiments of the present disclosure.

What is claimed is:

1. A method for log storage optimization, the method comprising:
receiving a log data;
converting the log data into a structured data using a parsing rule, wherein the parsing rule is at least one of a regular expression or a string template, and wherein the structured log profile at least is one of a timestamp or a content data of the log data; and
encoding the structured data to reduce a storage space of the log data.

2. The method according to claim 1, further comprising:
traversing a log profile repository after receiving the log data; and
determining whether the log profile repository includes a structured log profile corresponding to the log data to generate the parsing rule, the structured log profile repository being used to store a converted structured data.

3. The method according to claim 2, wherein determining whether the log profile repository includes a structured log profile corresponding to the log data to generate the parsing rule comprises at least one of:
if the log profile repository includes a structured log profile corresponding to the log data, generating a corresponding parsing rule according to a corresponding structured log profile; OR
if a structured log profile corresponding to the log data is missed in the log profile repository, obtaining the structured log profile and the parsing rule corresponding to the log data through an adaptive learning process, or receiving the structured log profile and the parsing rule corresponding to the log data from a user.

4. The method according to claim 2, further comprising:
prior to traversing the log profile repository, generating the structured log profile and the corresponding parsing rule according to a log configuration accessible to a device receiving the log data.

5. The method according to claim 1, wherein converting the log data into structured data using a parsing rule comprises:
setting a base time after converting the log data into the structured data using the parsing rule, wherein the base time is a timestamp of the first log or periodicity-based time;
determining a time difference between a timestamp of each log and the base time; and
replacing the timestamp in the structured data with the time difference.

6. The method according to claim 1, wherein encoding the structured data comprises:
for various types of values in the structured data, determining an occurrence frequency of each value in same type of values to generate the encoding rule.

7. The method according to claim 6, wherein generating the encoding rule comprises:
encoding a value having a larger occurrence frequency as a number having a shorter length, the occurrence frequency being proportional to occurrence times.

8. The method according to claim 7, wherein encoding a value having a larger occurrence frequency as a number having a shorter length comprises:
encoding a value having a maximum occurrence frequency with a numerical value “1”.

9. The method according to claim 6, wherein generating the encoding rule comprises:
generating automatically the encoding rule according to an adaptive learning process of the encoding rule; and wherein the encoding rule is Huffman encoding.

10. The method according to claim 1, further comprising:
storing the encoded structured data in the form of a log vector after encoding the structured data using the encoding rule.

11. An apparatus for log storage optimization, configured for:
receiving a log data;
converting the log data into a structured data using a parsing rule, wherein the parsing rule is at least one of a regular expression or a string template, and wherein the structured log profile at least is one of a timestamp or a content data of the log data; and
encoding the structured data to reduce a storage space of the log data.

12. The apparatus according to claim 11, further configured for:
traversing a log profile repository after receiving the log data; and
determining whether the log profile repository includes a structured log profile corresponding to the log data to generate the parsing rule, the structured log profile repository being used to store a converted structured data.

13. The apparatus according to claim 12, wherein determining whether the log profile repository includes a structured log profile corresponding to the log data to generate the parsing rule configured for at least one of:
if the log profile repository includes a structured log profile corresponding to the log data, generating a corresponding parsing rule according to a corresponding structured log profile; OR
if a structured log profile corresponding to the log data is missed in the log profile repository, obtaining the structured log profile and the parsing rule corresponding to the log data through an adaptive learning process, or receiving the structured log profile and the parsing rule corresponding to the log data from a user.

14. The apparatus according to claim 12, further configured for:
prior to traversing the log profile repository, generating the structured log profile and the corresponding parsing rule according to a log configuration accessible to a device receiving the log data.

15. The apparatus according to claim 11, wherein converting the log data into structured data using a parsing rule configured for:
setting a base time after converting the log data into the structured data using the parsing rule, wherein the base time is a timestamp of the first log or periodicity-based time;
determining a time difference between a timestamp of each log and the base time; and
replacing the timestamp in the structured data with the time difference.

16. The apparatus according to claim 11, wherein encoding the structured data configured for:
for various types of values in the structured data, determining an occurrence frequency of each value in same type of values to generate the encoding rule.

17. The apparatus according to claim 16, wherein generating the encoding rule configured for:
encoding a value having a larger occurrence frequency as a number having a shorter length, the occurrence frequency being proportional to occurrence times.

18. The apparatus according to claim 17, wherein encoding a value having a larger occurrence frequency as a number having a shorter length configured for:
encoding a value having a maximum occurrence frequency with a numerical value “1”.

19. The apparatus according to claim 16, wherein generating the encoding rule configured for:
generating automatically the encoding rule according to an adaptive learning process of the encoding rule; and wherein the encoding rule is Huffman encoding.

20. A computer program product for log storage optimization, comprising computer-readable program instructions embodied thereon, the computer-readable program instructions, when executed by a processor, causing the processor to:
receiving a log data;
converting the log data into a structured data using a parsing rule, wherein the parsing rule is at least one of a regular expression or a string template, and wherein the structured log profile at least is one of a timestamp or a content data of the log data; and
encoding the structured data to reduce a storage space of the log data.
